(19) United States
(12) Patent Application Publication
(10) Pub. No.: US 2011/0180750 A1
(43) Pub. Date: Jul. 28, 2011

(54) METHOD FOR PREPARING A SUSPENSION OF NANOPARTICULATE METAL BORIDES

(75) Inventors: Frank Kleine Jaeger, Bad Durkheim (DE); Joerg Koch, Birkenheide (DE); Johannes Loebel, Mannheim (DE)

(73) Assignee: BASF SE, Ludwigshafen (DE)

(21) Appl. No.: 13/122,514

(22) PCT Filed: Oct. 26, 2009
(86) PCT No.: PCT/EP09/64063

§ 371 Date: Apr. 4, 2011

(30) Foreign Application Priority Data
Oct. 27, 2008 (EP) 08167612.4

(51) Int. Cl. C09K 3/00; B82Y 30/00

(52) U.S. Cl. 252/182.3; 252/182.32; 252/182.33; 252/182.12; 977/773

(57) ABSTRACT

The present invention relates to a method for preparing a suspension of at least one nanoparticulate metal boride, in which a) at least one metal boride starting material is prepared, b) the metal boride starting material is subjected to a thermal treatment under plasma conditions, c) the product obtained in step b) is subjected to rapid cooling, d) the cooled product obtained in step c) is added to a fluid, wherein a suspension is obtained.

The present invention relates to a process for producing a suspension of at least one nanoparticulate metal boride.

WO 2007/107407 describes a fully dispersed, nanoparticulate preparation, comprising a carrier medium which is liquid under standard conditions and at least one particulate phase of nanosize metal boride particles dispersed therein. The nanoparticulate preparation is produced by incorporating at least one metal boride MB₆ into the carrier medium with simultaneous comminution, preferably with milling.

JP-B 06-039326 teaches the production of nanoparticulate metal borides by vaporization of the boride of a metal of groups Ia, IIa, IIIa, IVa, Va or VIa of the Periodic Table or by vaporization of a mixture of the corresponding metal with boron in a hydrogen or hydrogen/inert gas plasma and subsequent condensation.

JP-A 2003-261323 describes the preparation of nanoparticulate metal borides by reaction of the metal powders and/or metal boride powders with boron powder in the plasma of an inert gas.

WO 2006/134141 relates to a process for preparing essentially isometric nanoparticulate lanthanide/boron compounds, in which

a) i) one or more lanthanide compounds,
ii) one or more boron compounds,
and
iii) optionally, one or more reducing agents
dispersed in an inert carrier gas are mixed with one another,

b) the mixture of the components i), ii) and optionally iii) in the inert carrier gas is reacted by thermal treatment within a reaction zone,

c) the reaction product obtained in step b) by thermal treatment is subjected to rapid cooling and

e) precipitation of the reaction product cooled in step c) is subsequently brought about,

where the cooling conditions in step c) are selected so that the reaction product consists of essentially isometric nanoparticulate lanthanide/boron compounds or comprises essentially isometric nanoparticulate lanthanide/boron compounds.

WO 2007/128821 describes a process for producing suspensions of nanoparticulate solids, in which

a) at least one starting material and possibly further components are passed through at least one reaction zone and thereby subjected to a thermal treatment in which nanoparticulate primary particles are formed,

b) the reaction product obtained in step a) is subjected to rapid cooling and

c) the cooled reaction product obtained in step b) is introduced into a liquid so as to form a suspension in which the solids comprised are present in the form of nanoparticulate primary particles or very small aggregates.

In ISPC 18 Kyoto, Japan, Aug. 21-31, 2007, J. Szépvölgyi et al. describe the in-situ plasma synthesis of LaB₆ nanopowders from boron and La₂O₃.

For the purposes of the present invention, the term in-situ plasma synthesis refers to the simultaneous synthesis of a metal boride from appropriate starting materials and provision of nanosized particles which can then be suspended in a carrier medium. This process is well suited to the production of suspensions, in which the disperse phase is in the form of nanoparticulate primary particles or in the form of very small agglomerates. However, it is in need of improvement as far as the purity of the metal borides obtained is concerned. Various applications demand metal boride preparations which are transparent in the visible region of the electromagnetic spectrum and are essentially colorless. This applies, for example, to laser welding and the marking of plastic parts made of transparent plastics. Here, high-purity metal borides, e.g. LaB₆, allow the required small amounts used and avoidance of visible impurities.

There is also a great need for processes for producing nanoparticulate preparations of metal borides having a high purity.

It has now surprisingly been found that this object is achieved by a process in which

a) at least one metal boride starting material is provided,

b) the metal boride starting material is subjected to thermal treatment under plasma conditions,

c) the product obtained in step b) is subjected to rapid cooling,

d) the cooled product obtained in step c) is introduced into a liquid to give a suspension.

For the purposes of the present patent application “nanosize particles” are particles having a volume average particle diameter of generally not more than 500 nm, preferably not more than 200 nm. A preferred particle size range is from 1 to 150 nm, in particular from 2 to 100 nm. Such particles generally have a high uniformity in terms of their size, size distribution and morphology. The particle size can, for example, be determined by the UPA method (Ultrafine Particle Analyzer) e.g. by the laser light backscattering method.

For the purposes of the present invention, the term “standard conditions” refers to a standard temperature of 25° C.=298.15 K and a standard pressure of 101 325 Pa.

Step a)

The provision of the metal boride starting material in step a) (e.g. by synthesis from suitable starting materials) is, according to the invention, not carried out in-situ together with the thermal treatment under plasma conditions in step b).

In step a), preference is given to providing at least one metal boride in non-nanoparticulate form. The average particle size of the metal boride particles is then preferably in the range from 0.1 to 500 μm, particularly preferably from 0.5 to 50 μm, in particular from 1 to 20 μm.

The metal boride starting material provided in step a) preferably comprises a metal boride selected from among alkaline earth metal borides, rare earth metal borides and mixtures thereof. Preference is given to metal borides of the formula MB₆, where M is a metal component. As metal hexaborides MB₆, preference is given to yttrium, lanthanum, cerium, praseodymium, neodymium, samarium, europium, gadolinium, terbium, dysprosium, holmium, erbium, thulium, ytterbium, strontium and calcium hexaborides. A particularly preferred metal boride is a lanthanum hexaboride.

Methods of preparing and purifying nonnanoparticulate metal borides, e.g. LaB₆, are known to those skilled in the art. Nonnanoparticulate metal borides of high purity are also commercially available, e.g. from H.C. Starck International Sales GmbH, Goslar. Metal borides from the plasma synthesis process are preferably subjected to purification to remove synthesis-specific impurities before they are used in the process of the invention.

Step b)

In step b) of the process of the invention, the metal boride starting material from step a) is subjected to a thermal treatment under plasma conditions.

The generation of the plasma and the treatment of the metal boride starting material can be carried out in apparatuses customary for this purpose. Thus, for example, a microwave plasma or an electric arc plasma can be used. In a preferred embodiment, a plasma spray gun is used for generating the plasma. It comprises, for example, a housing serving as anode and a water-cooled copper cathode which is arranged centrally therein, with an electric arc of high energy density burning between the cathode and the housing. The plasma gas introduced ionizes to form the plasma and leaves the gun at high speed (e.g. from about 300 to 700 m/s) at temperatures in, for example, the range from 15 000 to 20 000 kelvin. To carry out the treatment of the metal boride starting material the latter is preferably introduced directly to this plasma jet, vaporized there and subsequently converted back into the solid state.

To generate the plasma, it is usual to use a gas or gas mixture. Here, a distinction is made between the actual plasma gas, the carrier gas which may optionally be used for introducing the metal boride and the sheathing gas optionally used (gas stream which sheathes the actual treatment zone, e.g. in order to avoid deposits on the wall). Plasma gas, sheathing gas and carrier gas can all have the same composition, two of the gases can have the same composition or all three can have a different composition. The gases or gas mixtures used as plasma gas, sheathing gas or carrier gas usually contain at least one noble gas. Preferred noble gases are helium, argon and mixtures thereof.

Preference is given to using argon, helium or a mixture thereof as plasma gas. Particular preference is given to using a noble gas/hydrogen mixture, in particular an argon/hydrogen mixture, as plasma gas. The volume ratio of noble gas to hydrogen, especially argon to hydrogen, is preferably in the range from about 1:1 to 20:1, particularly preferably 1:1 to 10:1.

In a specific embodiment, the metal boride is fed into the treatment zone with the aid of a carrier gas. As carrier gas, preference is given to using argon, helium or a mixture thereof. The introduction of the metal boride into the treatment zone can be effected using customary apparatuses known to those skilled in the art for transport as a dispersion in a stream of gas. For this purpose, a pulverulent metal boride starting material can be dispersed in the carrier gas. This preferably results in formation of an aerosol. The average particle size of the metal boride particles (or in the case of aggregates the particle aggregates) is preferably in the range from 0.1 to 500 μm, particularly preferably from 0.5 to 50 μm, in particular from 1 to 10 μm. The loading of the carrier gas with solid is usually from 0.01 to 5.0 g/l, preferably from 0.05 to 1 g/l.

Furthermore, the metal boride starting material can be converted into the gas phase before entry into the treatment zone. For this purpose, the metal boride starting material can be vaporized by means of, for example, a microwave plasma, electric arc plasma or by convectionably radiative heating, etc. and introduced into the carrier gas.

In a specific embodiment, a sheathing gas is additionally used in the thermal treatment. The sheathing gas serves as protective gas, which forms a gas layer between the wall of the apparatus used for generation of the microwave plasma and the treatment zone. The treatment zone in this case corresponds spatially to the region in which the plasma is located. Preference is given to using argon, helium or a mixture thereof as sheathing gas.

It is also possible to replace the noble gases in the abovementioned gases and gas mixtures either partly or completely by nitrogen. The conditions in the treatment are then preferably selected so that the formation of nitrides is avoided, e.g. by means of a treatment temperature which is not too high.

The power introduced into the plasma is typically in the range from a few kW to a number of 100 kW. Sources for plasma of high power can also be used in principle for the treatment. Otherwise, the method of generating a stationary plasma flame is well known to those skilled in the art, in particular in respect of power introduced, gas pressure, amount of gas for the plasma, carrier and sheathing gases.

The treatment in step b) according to the invention results, after nucleation has occurred, firstly in nanoparticulate primary particles which can undergo further particle growth by coagulation and coalescence processes. Particle formation and growth typically occur in the total treatment zone and can also continue after leaving the treatment zone until the rapid cooling in step c). If more than one metal boride is used for the treatment, it is also possible for the different primary particles formed to join to one another so as to form nanoparticulate product mixtures, for example, in the form of mixed crystals or amorphous mixtures. The particle formation processes can be controlled via the composition and concentration of the starter materials and also by means of the type of cooling described in step c) of the treatment product and the point in time at which this occurs.

The treatment under plasma conditions in step b) is preferably carried out at a temperature in the range from 600 to 25 000° C., preferably from 800 to 20 000° C. The residence time of the metal boride in the reaction zone is generally from 0.002 s to 2 s, preferably from 0.005 s to 0.2 s.

The treatment in step b) in the process of the invention can be carried out at any pressure, preferably a pressure in the range from 0.05 bar to 5 bar, in particular about atmospheric pressure.

Step c)

The treatment of the metal boride starting material in step b) is, according to the invention, followed by rapid cooling of the resulting treatment product in step c).

The cooling rate in step c) is preferably at least 10⁴ K/s, particularly preferably at least 10⁵ K/s, in particular at least 10⁶ K/s. When cooling is carried out in two or more than two stages, the cooling rate in at least the first stage is generally in the above-mentioned range.

This rapid cooling can, for example, be effected by direct cooling, indirect cooling, expansion cooling or a combination of direct and indirect cooling.

In the case of direct cooling (quenching), a coolant is brought into direct contact with the hot treatment product from step b) in order to cool the product. Direct cooling can, for example, be carried out by introduction of quenching oil, water, steam, liquid nitrogen or cold gases, optionally also cold recycle gases, as coolant. The introduction of the coolant can be carried out using, for example, an annular gap burner which makes very high and uniform quenching rates possible and is known per se to those skilled in the art.

In the case of indirect cooling, heat energy is withdrawn from the reaction product without it coming into direct contact with a coolant. An advantage of indirect cooling is that it generally allows effective utilization of the heat energy transferred to the coolant. For this purpose, the reaction product can be brought into contact with the exchange areas of a suitable heat exchanger. The heated coolant can, for example, be used for heating the metal boride starting material in the process of the invention or be used in a different endothermic process. Furthermore, the heat withdrawn from the reaction product can also, for example, be used for operating a steam generator.

The process of the invention is preferably carried out so that the reaction product obtained is cooled to a temperature in the range from 1800° C. to 10° C. in step c).

In a preferred embodiment of the invention, the cooling in step c) is carried out in at least two stages and in particular in two stages.

When cooling in two or more than two stages, identical or different cooling methods can be used. Preference is given to combined use of indirect cooling (pre-quench) and direct cooling.

In the first stage, the product is preferably cooled to not more than 1000° C., particularly preferably not more than 800° C., in particular not more than 650° C.

In the second stage, the product is preferably cooled to not more than 300° C., particularly preferably not more than 200° C., in particular not more than 150° C.

In the case of multistage cooling, the product is preferably subjected in the first stage to very rapid cooling (i.e. at a very high cooling rate of at least 10⁵ K/s, particularly preferably at least 10⁶ K/s), to a temperature below the melting point or decomposition temperature.

Cooling in step c), as described above, can prevent undesirable growth of the particles after exit from the treatment zone and aggregation or sintering thereof.

The size of the solid particles after cooling in step c) and in the suspensions of nanoparticulate metal borides produced by the process of the invention is usually not more than 500 nm, preferably not more than 200 nm. A preferred particle size range is from 1 to 150 nm, in particular from 2 to 100 nm. The particles generally have a high uniformity in terms of their size, size distribution and morphology.

In a further embodiment of the process of the invention, further processing of the resulting particles can be carried out in the gas phase during or immediately after quenching, for example treatment with an organic modifier. In this way, the surface of the metal boride particles can be at least partly coated with the modifier or a product formed therefrom or be modified by reaction with the modifier or a product formed therefrom. In this case, quenching gas and modifier are preferably added simultaneously. Organic compounds suitable as modifiers are known in principle to those skilled in the art. Preference is given to using compounds which can be converted into the gas phase without decomposition and can form a covalent or adhesive bond to the surface of the particles formed. The coating and/or modification can be carried out using, for example, at least one organosilane, such as dimethyldimethoxysilane, methyltrimethoxysilane, methyltriethoxysilane, methylcyclohexyldimethoxysilane, isooctyltrimethoxysilane, propyltrimethoxysilane, isobutyltrimethoxysilane, phenyltrimethoxysilane or octyltriethoxysilane.

It is expected that the silanes present on the surface of the particles can act as spacers and reduce the interactions between the particles, aid mass transfer into an organic matrix in the wet precipitator and function as coupling points in any subsequent further functionalization (optionally after concentration).

The modification process is preferably carried out so that targeted condensation of the modifier on the particles occurs as a result of the introduction of the quenching gas or controlled removal of heat after introduction of the quenching gas. In addition, further aqueous or organic modifiers can be added in a subsequent step to aid condensation.

A specific embodiment is the use of modifier which is also comprised in the liquid used in step d).

Step d)

The liquid used in step d) functions as carrier medium (coherent phase) of the nanoparticulate suspensions according to the invention. The liquid used in step d) is liquid under standard conditions. The boiling point of the liquid (or of the liquid mixture) is preferably at least 40° C., particularly preferably at least 65° C.

The liquid can be water, a water-immiscible, partly water-miscible or completely water-miscible organic or inorganic liquid or a mixture of at least two of these liquids.

The liquid is preferably selected from among esters of alkylcarboxylic and arylcarboxylic acids, hydrogenated esters of arylcarboxylic acids, polyhydric alcohols, ether alcohols, polyether polyols, ethers, saturated acyclic and cyclic hydrocarbons, mineral oils, mineral oil derivatives, silicone oils, aprotic polar solvents, ionic liquids and mixtures thereof.

Suitable liquid esters of alkylcarboxylic acids are preferably based on a C₁-C₂₀-alkanecarboxylic acid. This is preferably selected from among formic acid, acetic acid, propionic acid, butyric acid, valeric acid, caproic acid, enanthic acid, caprylic acid, 2-ethylhexane acid, pelargonic acid, capric acid, undecanoic acid, lauric acid, tridecanoic acid, myristic acid, pentadecanoic acid, palmitic acid, margaric acid, stearic acid, nonadecanoic acid and arachic acid. The esters are preferably based on the alkanols, polyhydric alcohols, ether alcohols and polyether alcohols mentioned below. They preferably include the diesters of the abovementioned alkylcarboxylic acids with oligoalkylene and polyalkylene glycols, especially oligoalkylene and polyalkylene glycols. Suitable diesters of this type are, for example, diethylene glycol bis(2-ethylhexanoate) and triethylene glycol bis(2-ethylhexanoate).

Suitable esters of arylcarboxylic acids are preferably esters of phthalic acid with alkanols, in particular the esters with C₁-C₃₀-alkanols, especially C₁-C₂₀-alkanols and very especially C₁-C₁₂-alkanols. Such compounds are commercially available e.g. as plasticizers. Examples of alkanols are, in particular, methanol, ethanol, propanol, isopropanol, n-butanol, isobutanol, sec-butanol, tert-butanol, n-pentanol, 2-pentanol, 2-methylbutanol, 3-methylbutanol, 1,2-dimethylpropanol, 1,1-dimethylpropanol, 2,2-dimethylpropanol, 1-ethylpropanol, n-hexanol, 2-hexanol, 2-methylpentanol, 3-methylpentanol, 4-methylpentanol, 1,2-dimethylbutanol, 1,3-dimethylbutanol, 2,3-dimethylbutanol, 1,1-dimethylbutanol, 2,2-dimethylbutanol, 3,3-dimethylbutanol, 1,1,2-trimethylpropanol, 1,2,2-trimethylpropanol, 1-ethylbutanol, 2-ethylbutanol, 1-ethyl-2-methylpropanol, n-heptanol, 2-heptanol, 3-heptanol, 2-ethylpentanol, 1-propylbutanol, n-octanol, 2-ethylhexanol, 2-propylheptanol, 1,1,3,3-tetramethylbutanol, nonanol, decanol, n-undecanol, n-dodecanol, n-tridecanol, iso-tridecanol, n-tetradecanol, n-hexadecanol, n-octadecanol, n-eicosanol and mixtures thereof.

Suitable polyhydric alcohols are for example, ethylene glycol, glycerol, 1,2-propanediol, 1,4-butanediol, etc. Suitable ether alcohols are, for example, compounds having two terminal hydroxyl groups which are joined by an alkylene group which may have 1, 2 or 3 nonadjacent oxygen atoms. Such ether alcohols include, for example, ethylene glycol monomethyl ether, ethylene glycol dimethyl ether, ethylene glycol diethyl ether, etc. Polyether polyols, e.g. polyalkylene glycols, which are liquid under standard conditions, are also suitable. These include compounds having terminal hydroxyl groups and repeating units which are preferably selected from among (CH₂CH₂O)ₓ₁, (CH(CH₃)CH₂O)ₓ₂ and ((CH₂)₄O)ₓ₃, where x1, x2 and x3 are each, independently of one another, an integer from 0 to 2500, with the proviso that at least one of the values x1, x2 or x3 is different from 0. Preference is given to x1, x2 and x3 each being, independently of one another, an integer from 1 to 2500, particularly preferably from 4 to 2500, in particular from 5 to 2000. The sum of x1, x2 and x3 is preferably an integer from 4 to 2500, in particular from 5 to 2000. In polyoxyalkylenes, having two or three different repeating units, the order is immaterial, i.e. the repeating units can be randomly distributed, alternate or be arranged in blocks. Preference is given to polyethylene glycol, polypropylene glycols, polyethylene glycol-co-propylene glycols and polytetrahydrofurans. Polytetrahydrofuran is preferred as carrier medium. Suitable ethers are acyclic and cyclic ethers, preferably cyclic ethers, particularly preferably tetrahydrofuran.

Suitable saturated acyclic and cyclic hydrocarbons are, for example, tetradecane, hexadecane, octadecane, xylenes and decahydronaphthalene.

Further suitable liquids are paraffin and paraffin oils, high-boiling mineral oil derivatives, such as decalins and white oil, and also liquid polyolefins.

Aprotic polar solvents suitable as liquid include, for example, amides, such as formamide or dimethylformamide, dimethyl sulfoxide, acetonitrile, dimethyl sulfone, sulfolane, and in particular nitrogen heterocycles, such as N-methylpyrrolidone, quinoline, quinaldine, etc.

In a specific embodiment, water is not used as liquid. However, it can be advantageous to use a liquid comprising small amounts of water, generally not more than 5% by weight, preferably not more than 1% by weight, based on the total weight of the liquid. Clearly defined small amounts of water can contribute to stabilization of the nanoparticulate preparation according to the invention. This also applies when liquids which are only slightly miscible with water are used.

To introduce the cooled product obtained in step c) into a liquid (step d), it is possible to use customary apparatuses known to those skilled in the art. These include, for example, wet electroprecipitator or Venturi scrubbers. The product obtained in step c) is preferably introduced into the liquid using a Venturi scrubber in step d).

Optionally, the nanoparticulate solids formed can be fractionated during precipitation, for example by fractional precipitation. Precipitation can possibly be intensified by condensation and the suspension formed can be stabilized further by means of modifiers. Suitable substances for surface modification are anionic, cationic, amphoteric or nonionic surfactants, for example, Lutensol® or Sokalan® grades from BASF SE.

In a useful embodiment of the invention, a surfactant-comprising liquid is fed continuously into the upstream part of a wet electroprecipitator. Owing to the generally vertical arrangement of the wet electroprecipitator, a closed liquid film is formed on the wall inside the tubular precipitation vessel of the wet electroprecipitator. However, the liquid which is continuously circulated is collected in the downstream part of the wet electroprecipitator and conveyed via a pump. The gas stream laden with the nanoparticulate solid preferably flows through the wet electroprecipitator in countercurrent to the liquid. A centrally arranged wire which functions as spray electrode is located in the tubular precipitation vessel. A voltage of about 50-70 kV is applied between the vessel wall which serves as counterelectrode and the spray electrode. The gas stream laden with the nanoparticulate solid flows from the top into the precipitation vessel where the gas-borne particles are electrically charged by the spray electrode and precipitation of the particles on the counterelectrode (i.e. the wall of the wet electroprecipitator) is thus induced. Owing to the liquid film flowing along the wall, the particles are deposited directly in the film. In this way, the charging of the particles simultaneously avoids undesirable particle agglomeration. The surfactant leads to formation of a stable suspension. The degree of precipitation is generally above 95%.

In a further preferred embodiment of the invention, a Venturi scrubber is used for introducing the nanoparticulate metal boride into the liquid. Venturi scrubbers are widespread, e.g. as wet dust removal system for separating fine dusts from dust-laden gases. The gas laden with nanoparticulate metal boride enters the Venturi scrubber in, for example, a vertical direction from the top into the conical inlet zone (confusor) and is accelerated, e.g. to a velocity of up to 100 m/s. To avoid deposits and/or to achieve partial saturation of the gas at this stage, the confusor surface can be wetted by tangential spraying-in of liquid. To precipitate the metal boride, liquid is sprayed in perpendicular to the gas flow at the narrowest point of the Venturi scrubber, namely the Venturi throat, and is broken up into very fine droplets. Here, the solid particles in the gas are absorbed on droplets of the liquid. An adjustable throat which is, for example, regulated via the differential pressure enables constant precipitation to be achieved. In the subsequent diffuser of the Venturi tube, conversion of kinetic energy into pressure energy takes place; as a result, the liquid mist coalesces into larger droplets which are precipitated in a downstream separator (droplet precipitator). Owing to the high turbulence in the region of the Venturi throat, very efficient precipitation of the nanoparticulate solids occurs. Optionally, surfactants can be added to the liquid serving as precipitation medium in order to additionally discourage agglomeration of precipitated particles. A pressure difference over the throat to the Venturi scrubber in the range from 20 to 1000 mbar, particularly preferably from 150 to 300 mbar, is preferably set. This method enables nanoparticles having the small particle diameters sought, e.g. less than 60 nm, to be precipitated at a degree of precipitation of greater than 90%.

For the work-up, the product obtained in step c) can be subject to at least one separation and/or purification step before being introduced into a liquid. However, the plasma treatment according to the invention advantageously makes it possible to produce nanoparticulate metal borides in very high purities, so that a separation and/or purification step before introduction into the liquid is generally not necessary.

The process of the invention is suitable for the continuous or batchwise production of suspensions of nanoparticulate metal borides. Important features of this process are rapid introduction of energy to a high temperature level, generally short and uniform residence times under the plasma conditions and rapid cooling (“quenching”) of the treatment products with subsequent transfer of the particles into a liquid phase, as a result of which agglomeration of the nanoparticulate primary particles formed can be at least largely avoided. The products which can be obtained by the process of the invention can easily be processed further and make it possible to achieve new materials properties attributable to nanoparticulate solids in a simple manner.

The average particle size of the solid particles in the suspensions of nanoparticulate metal borides produced by the process of the invention is usually not more than 500 nm, preferably not more than 200 nm. A preferred particle size range is from 1 to 150 nm, in particular from 2 to 100 nm.

In the suspensions produced by the process of the invention, the disperse phase is present in the form of nanoparticulate primary particles or in the form of very small agglomerates. In addition, they have a high purity of the metal borides comprised.

The suspensions produced according to the invention are transparent in the visible region of the electromagnetic spectrum and are essentially colorless. As a result, the appearance of compositions, especially polymer compositions, comprising such a nanoparticulate metal boride is advantageously only barely discernable to not discernable by the naked eye. Furthermore, the considerable scattering in the visible spectral region which is observed in the case of microdispersed additives is avoided, so that even transparent plastics very readily can be written on using the compositions according to the invention and by the method according to the invention for marking plastic parts. On the other hand, the nanoparticulate metal borides used according to the invention display strong absorption in the IR region (from about 700 to 12 000 nm), preferably in the NIR region from 700 to 1500 nm, particularly preferably in the range from 900 to 1200 nm. The fully dispersed nanoparticulate preparations according to the invention are thus advantageously well suited as additives for high molecular weight organic and inorganic compositions, in particular plastics, surface coatings and printing inks, for use in organic and inorganic composites and oxidic layer systems. They are particularly suitable as additives for the laser welding of plastics and in plastics processing carried out with heating. Radiation sources (e.g. heat lamps) are frequently used for the processing of plastics with heating. These generally have a broad emission spectrum, e.g. in the range from about 500 to 1500 nm. However, many plastics absorb radiation to an insufficient extent in this wavelength range, which leads to high energy losses. This applies particularly to polyesters, in particular polyethylene terephthalates, as are used, for example, in the production of bottles by blow molding. The nanoparticulate preparations according to the invention are especially suitable as “reheat” additives for such plastics. The nanoparticulate preparations according to the invention are also suitable as component of compositions for electrophotography, as components of compositions for security printing and as component of compositions for controlling the energy transfer properties. These include compositions, as are used, for example, in solar energy management, e.g. plastic thermal insulation glasses, thermal insulation films (e.g. for agricultural applications such as greenhouses), thermal insulation coatings, etc. The dispersed nanoparticulate preparations of the invention are also suitable in a particularly advantageous way as additives to plastics which are to be subjected to laser marking (e.g. by means of an Nd-YAG laser at 1064 nm).

Furthermore, the suspensions produced according to the invention have good thermal stability which extends, for example, up to 200° C., frequently also up to 300° C. and more. They can therefore be incorporated without decomposition directly into a polymer composition by conventional, inexpensive and process-simplified methods of addition of additives to a composition. Since they are, advantageously, degraded neither by heat nor by radiation, they make it possible to set the polymer composition to a desired shade of color which is not altered by the subsequent marking, except in the denoted region. The stability of the nanoparticulate metal borides used according to the invention also allows them to be used for applications in which the formation of undefined degradation products has to be ruled out, for example applications in the medical sector and in the food packaging sector.

Finally, the nanoparticulate metal borides according to the invention are very largely migratory stable in all conventional matrix polymers, which is likewise a fundamental prerequisite for use in the medical sector and the food packaging sector.

The invention is illustrated by the following nonlimiting examples.

### EXAMPLE 1

Production of nanoparticulate LaB₆ in an organic medium by a plasma process with integrated wet particle precipitation

A plasma spray gun is used in the process of the invention for producing LaB₆. Here, the energy necessary for vaporizing of the particulate starting materials is generated by a high-temperature plasma. A gas-stabilized electric arc having a high energy density burns on a centrally arranged, water-cooled copper anode. The electric power introduced here is 45 kW, with approximately 50% of the power being removed by the cooling water and the remainder remaining as thermal power in the system. The gas fed to the gun (50 standard l/min of argon+15 standard l/min of hydrogen) ionizes to form the plasma and leaves the burner nozzle at a high velocity (about 300 to 700 m/s) at local temperatures of about 15 000 to 20 000 K. To minimize deposits on the walls, a sheathing stream of 10 standard m³/h of argon is additionally fed in via the reactor inlet. As starting material, pulverulent LaB₆ (d₅₀=6 μm) is fed into the high-temperature zone of the plasma immediately downstream of the exit nozzle of the spray gun by pneumatic transport via two feed channels which are located opposite one another and through each of which 14 standard l/min of argon flows. The total feed rate of the LaB₆ is 100 g/h. In its inlet region, the reactor has a conical shape which corresponds to the widening of the free jet of the plasma and then goes over into a cylindrical shape. The reactor wall is cooled by means of heat transfer oil via a jacket. After travelling 1000 mm downstream, the gas stream is quenched from a temperature of about 600° C. to about 100° C. by means of 20 standard m³/h of nitrogen so that all of the LaB₆ in the gas phase is converted into the solid state. After the gas quench, the LaB₆ is present in nanoparticulate form and is then transferred directly by means of a Venturi scrubber into a liquid precipitation medium (triethylene glycol bis(2-ethylhexanoate)). The precipitation medium is atomized at a volume flow of about 200 l/h in the throat of the Venturi scrubber, which has a diameter of 14 mm, in order to bring about precipitation of the particles from the gas by absorption on the droplets. The pressure drop over the Venturi throat is about 200 mbar. The atomization section is followed by a centrifugal droplet precipitator provided with a downstream collection vessel having a volume of 15 l. The LaB6-laden precipitation medium is collected here. The particle-laden scrubbing medium is discharged continuously. At the transport rate selected, 300 g/h of nanoparticulate LaB₆ (particle size from 3 to 60 nm) are produced as 30% strength by weight suspension in triethylene glycol bis(2-ethylhexanoate) by means of the process of the invention.

1. A process for producing a suspension of at least one nanoparticulate metal boride, the process comprising:
(a) subjecting a metal boride starting material to thermal treatment under plasma conditions, to obtain a first product;
(b) subjecting the first product obtained in (a) to rapid cooling, to obtain a cooled product;
(c) introducing the cooled product obtained in (b) into a liquid to give the suspension.

2. The process of claim 1, wherein at least one metal boride in nonnanoparticulate form is employed in (a).

3. The process of claim 1, wherein the metal boride is at least one selected from the group consisting of an alkaline earth metal, boride and a rare earth boride.

4. The process of claim 1, wherein the cooling in (b) comprises a first cooling and a second cooling.

5. The process of claim 4, wherein the first cooling is effected by indirect cooling and the second cooling is effected by direct cooling.

6. The process of claim 4, wherein cooling to not more than 1000° C., is carried out in the first cooling.

7. The process of claim 4, wherein cooling to not more than 300° C., is carried out in the second cooling.

8. The process of claim 1, wherein the liquid in (c) is at least one selected from an ester of an alkylcarboxylic acid, an ester of an arylcarboxylic acids acid, a hydrogenated ester of an arylcarboxylic acid with an alkanol, a polyhydric alcohol, an ether alcohol, a polyether polyol, an ether, a saturated acyclic hydrocarbon, a saturated cyclic hydrocarbon, a mineral oil, a mineral oil derivative, a silicone oil, an aprotic polar solvent, and an ionic liquid.

9. The process of claim 1, wherein the cooled product obtained in (b) is introduced into the liquid with a Venturi scrubber in (c).

10. The process of claim 4, wherein cooling to not more than 800° C. is carried out in the first cooling.

11. The process of claim 4, wherein cooling to not more than 650° C. is carried out in the first cooling.

12. The process of claim 4, wherein cooling to not more than 200° C. is carried out in the second cooling.

13. The process of claim 4, wherein cooling to not more than 150° C. is carried out in the second cooling.

14. The process of claim 2, wherein the metal boride is at least one selected from the group consisting of an alkaline earth metal boride and a rare earth boride.

15. The process of claim 2, wherein the cooling in (b) comprises a first cooling and a second cooling.

16. The process of claim 3, wherein the cooling in (b) comprises a first cooling and a second cooling.

17. The process of claim 15, wherein the first cooling is effected by indirect cooling and the second cooling is effected by direct cooling.

18. The process of claim 16, wherein the first cooling is effected by indirect cooling and the second cooling is effected by direct cooling.

19. The process of claim 5, wherein cooling to not more than 1000° C. is carried out in the first cooling.

20. The process of claim 2, wherein the liquid in (c) is at least one selected from an ester of an alkylcarboxylic acid, an ester of an arylcarboxylic acid, a hydrogenated ester of an arylcarboxylic acid with an alkanol, a polyhydric alcohol, an ether alcohol, a polyether polyol, an ether, a saturated acyclic hydrocarbon, a saturated cyclic hydrocarbon, a mineral oil, a mineral oil derivative, a silicone oil, an aprotic polar solvent, and an ionic liquid.
